(19) United States
(12) Patent Application Publication
(10) Pub. No.: US 2017/0274611 A1
(43) Pub. Date: Sep. 28, 2017

(54) METHOD FOR SIMULTANEOUS PRODUCTION OF MULTIPLE POUCHES WITH TRANSVERSE DIRECTION RECLOSURE

(71) Applicant: Illinois Tool Works Inc., Glenview, IL (US)

(72) Inventors: James Howie JOHNSON, Glenview, IL (US); Eric PLOURDE, Glenview, IL (US)

(73) Assignee: ILLINOIS TOOL WORKS INC., Glenview, IL (US)

(21) Appl. No.: 15/505,684

(22) PCT Filed: Oct. 13, 2015
(86) PCT No.: PCT/US2015/055337

§ 371 Date: Feb. 22, 2017

Related U.S. Application Data
(60) Provisional application No. 62/063,228, filed on Oct. 13, 2014.

(51) Int. Cl. B31B 19/26

(52) U.S. Cl. CPC B31B 1/10; B31B 19/90; B31B 2219/146; B31B 2219/9022; B31B 2237/10; B31B 2237/403; B31B 2237/50

(57) ABSTRACT

The present disclosure relates to the simultaneous manufacture of reclosable packages or pouches by application of a closure or reclosure onto a package web or film in the transverse direction. The web or film is folded along a machine-direction centerline so that one half of the web or film overlies, or is coextensively aligned with, the other half of the web or film. Heat seals and slits are formed in the machine direction, thereby forming the side seals of the plurality of reclosable packages or pouches.

### BACKGROUND OF THE DISCLOSURE

This application claims priority under 35 U.S.C. 119(e) of U.S. provisional application Ser. No. 62/063,228, filed on Oct. 13, 2014, the contents of which is hereby incorporated by reference in its entirety and for all purposes.

### FIELD OF THE DISCLOSURE

The present disclosure relates to the simultaneous manufacture of reclosable packages by application of a closure or reclosure onto a package film in the transverse direction.

### DESCRIPTION OF THE PRIOR ART

In the prior art of transverse direction (TD) technology, the sequential production of individual packages is well-known. However, the production of multiple packages simultaneously has not been achieved. The simultaneous production of multiple packages on a single line would be expected to increase manufacturing speeds and reduce manufacturing costs.

### SUMMARY OF THE DISCLOSURE

The disclosure relates to the simultaneous production of multiple packages by transverse direction (TD) technology. First and second halves of a reclosure are aligned in a transverse direction to a sheet of web or film moving in a transverse direction. The sheet is folded along a machine direction longitudinal centerline so that first and second halves of the sheet overlie (or are otherwise coextensively aligned with) each other and the transversely oriented first and second halves of the reclosure likewise overlie (or are otherwise coextensive) each other. The first and second halves of the web or film are then sealed or otherwise attached to each other along multiple parallel machine direction seal lines, thereby defining the side seals of adjacent pouches or containers. Slits are then formed along the seal lines of adjacent pouches or containers, thereby separating the pouches or containers.

### BRIEF DESCRIPTION OF THE DRAWINGS

Further objects and advantages of the disclosure will become apparent from the following description and from the accompanying drawings, wherein:

FIG. 1 is a perspective view of a sheet, moving in the machine direction, in preparation for placement of a closure, reclosure, zipper or similar device, in accordance with the present disclosure.

FIG. 2 is a perspective view of the sheet of FIG. 1, shown after the placement of the a closure, reclosure, zipper or similar device, in a transverse direction, in accordance with the present disclosure.

FIG. 3 is an end view illustrating the folding of the sheet of FIG. 2, wherein the folding is along the machine-direction centerline, in accordance with the present disclosure.

FIG. 4 is a perspective view of the sheet of FIGS. 2 and 3, with one half of the sheet overlying the other half of the sheet, folded along the machine-direction centerline, in accordance with the present disclosure.

FIG. 5 is a plan view illustrating the heat sealing, crushing and slitting process steps on the folded sheet of FIG. 4, thereby simultaneously creating a plurality of pouches or containers, in accordance with the present disclosure.

FIG. 6 is a diagram of an alternative embodiment of the present disclosure,

FIG. 7 is a cross-sectional view showing two separate sheets, each having a reclosure profile attached to its inner wall.

FIG. 8 is a cross-sectional view showing two separate sheets, with the lower sheet being attached to a reclosure including interlocked profiles.

FIG. 9 is a cross-sectional view showing a single sheet in a C-fold configuration, with an internal self-mating reclosure.

FIG. 10 is a cross-sectional view showing a single sheet in a C-fold configuration with a reclosure including interlocked profiles in the central half of the expanse of the sheet.

FIG. 11 is a perspective view illustrating a reclosure with interlocked profiles attached to a single half of the sheet of web or film.

FIG. 12 is a perspective view illustrating a reclosure on one sheet of web or film with another sheet of web or film overlying or facing the sheet with the reclosure, similar to FIG. 8.

FIG. 13 is a plan view of a representative pouch or container formed by method of the present disclosure.

### DETAILED DESCRIPTION OF THE PREFERRED EMBODIMENT

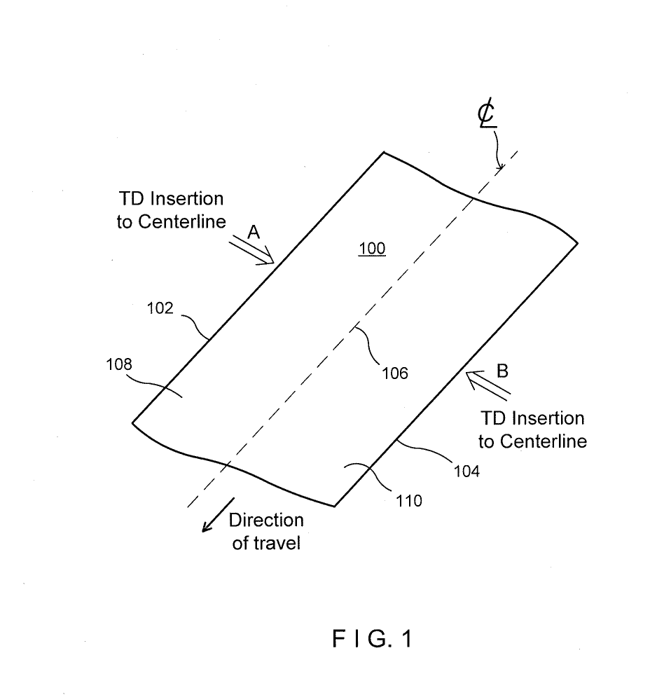

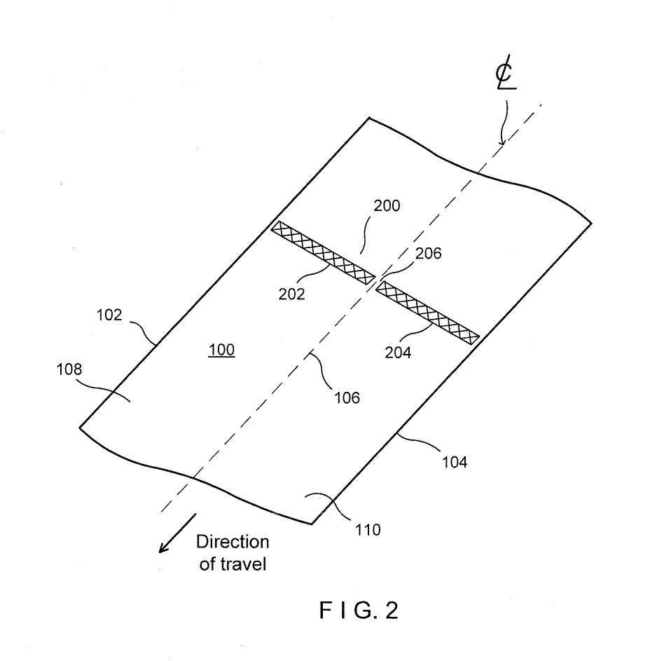

Referring now to the drawings in detail wherein like numerals refer to like elements throughout the several views, one see that FIG. 1 is a perspective view of a sheet of web or film 100, with lateral edges 102, 104, moving in the machine direction, as indicated, with a machine-direction (longitudinally oriented) centerline 106. The web or film 100 is typically a polymeric material, but is not limited thereto. The machine-direction centerline 106 demarcates the first half 108 of the web or film 100 from the second half 110 of the web or film 100. The transverse-directional insertion lines for the closure, reclosure, zipper or similar device 200 of FIG. 2 are indicated by arrows A and B.

FIG. 2 illustrates how closure, reclosure, zipper or similar device, including, but not limited to a VECTOR® style closure (which is a self-mating closure that can be folded back on itself and joined) is sealed or otherwise attached to the web or film 100 of FIG. 1 in the transverse direction, extending from lateral edge 102 to lateral edge 104. Other possible reclosures 200 are the MX24S product (by Illinois Tool Works Inc.), the VELCRO® product (or similar hook-and-eye) or the APLIX® product. The various possible closure devices will be collectively referred to and illustrated as reclosure 200, wherein first half 202 of reclosure 200 is sealed to first half 108 of the web or film 100 and second half 204 of reclosure 200 is sealed to second half 110 of the web or film 100. A gap 206 may be formed between first and second halves 202, 204 of reclosure 200. Reclosure 200 may, in some applications, preferably be a self-mating strip or VECTOR® in order to provide for the reclosable feature of the resulting pouches or products. In other applications, the first and second halves 202, 204 of reclosure 200 may be complementary interlockable profiles, such as, but not limited to, male and female interlockable profiles. The first half 202 of the reclosure 200 on first half 108 of the web or film 100 (to the left of machine-direction centerline 106 in the orientation of FIG. 2) is transversely end-wise aligned with the second half 204 of reclosure 200 on the second half 110 of the web or film 100 (to the right of machine-direction centerline 106 in the orientation of FIG. 2). This is typically achieved by maintaining reclosure 200 in a straight transversely-oriented alignment.

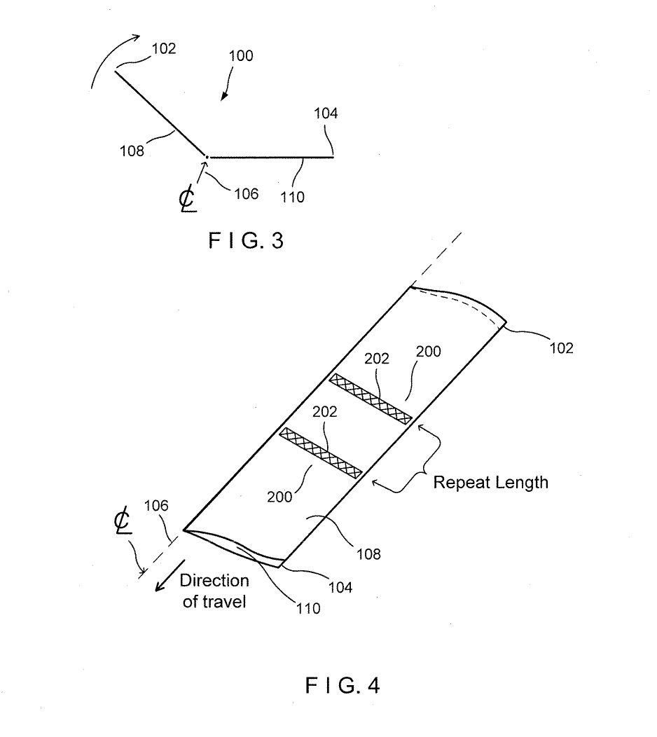

FIG. 3 illustrates the step of folding the web or film 100 about machine-direction centerline 106 resulting in the configuration of FIG. 4 wherein first half 108 of the web or film 100 overlies or is otherwise coextensively aligned with the second half 110 of the web or film 100. Additionally, the first half 202 of reclosure 200 overlies, is coextensive, or is in lengthwise alignment with, the second half 204 of reclosure 200 thereby interlocking the first and second halves 202, 204 of reclosure 200 with each other and forming a reclosable configuration.

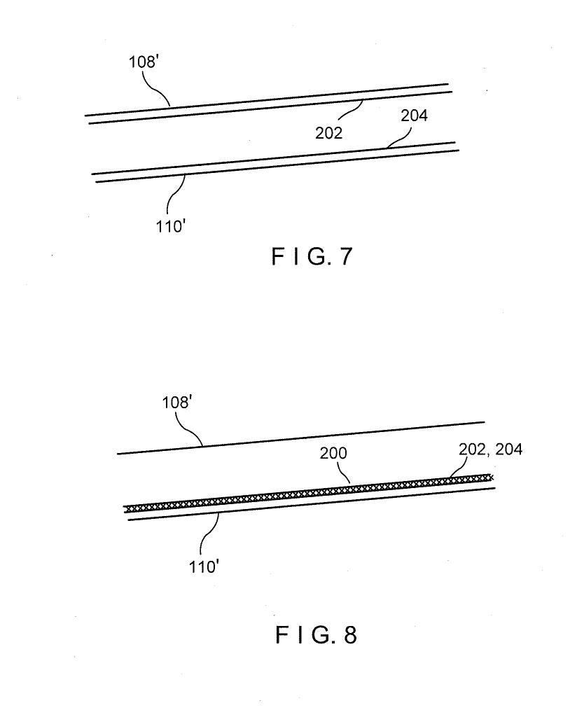

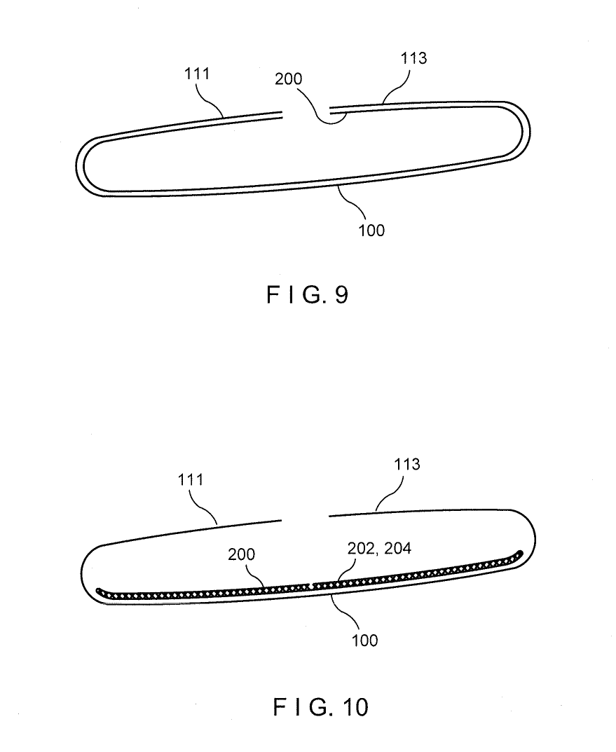

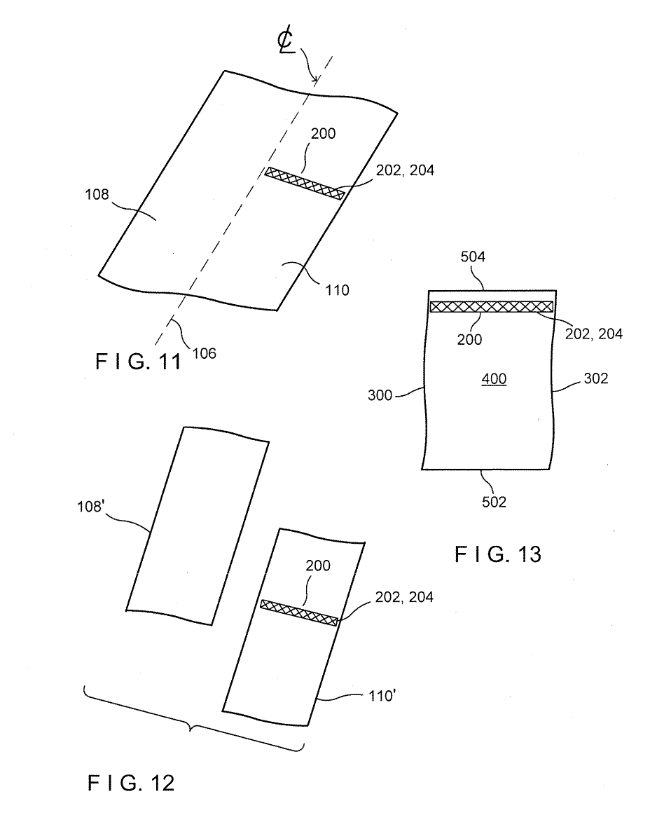

A configuration similar to that of FIG. 4 can be reached by using two separate webs 108′, 110′ with a respective first or second half 202, 204 of the reclosure 200, as illustrated in FIG. 7. This is particularly desirable in connection with sachet machines. Likewise, two separate webs 108′, 110′ may be used with a reclosure 200 with interlocked halves 202, 204 (i.e., reclosure profiles) sealed or otherwise attached to web 110′ as illustrated in FIGS. 8 and 12, with web 108′ subsequently sealed or otherwise attached to the reclosure 200. Similarly, a reclosure 200 with first and second interlocked halves 202, 204 (i.e., reclosure profiles) can be sealed or otherwise attached to second half 108 of web 100 and first half 106 folded thereover as illustrated in FIG. 11, and subsequently sealed or otherwise attached thereto. Further, a C-folded web 100 with either a self-mating reclosure 200 extending around the entire interior of the web 100, with lateral quarters 111, 113 of the web 100 folded over the central half of web 100 may be implemented as shown in FIG. 9 or a reclosure 200 with interlocked halves 202, 204 (i.e., reclosure profiles) attached to a central half of the web 100 as illustrated in FIG. 10 and the lateral quarters 111, 113 of the web 100 folded over the central half and sealed or otherwise attached to reclosure 200. Finally, a plurality of reclosures 200 (i.e., as reclosure segments), typically one for each pouch or container, may be simultaneously provided across the web 100 with cross-seals formed between the reclosure segments.

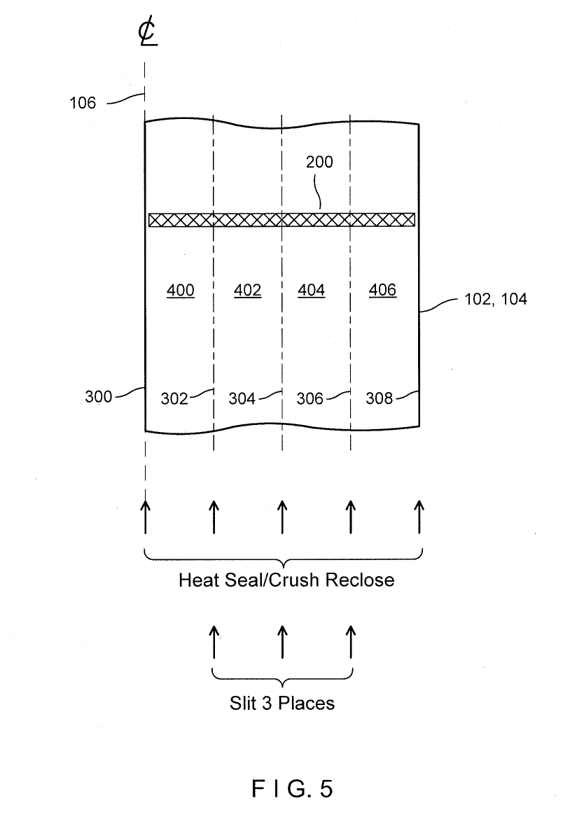

FIG. 5 illustrates the step after reaching the configuration of FIG. 4 or any of the above-identified similar configurations of FIGS. 7-12. Parallel-spaced heat seal lines 300, 302, 304, 306, 308, which may be formed simultaneously, join first and second halves 108, 110 of the web or film 100, with a crushing operation on reclosure 200 (thereby joining portions of first and second halves 202, 204 of reclosure 200) at the intersection with heat seal lines 300, 302, 304, 306, 308. This forms the sidewalls of four simultaneously formed packages or pouches 400, 402, 404, 406. The package forming operation is completed by slitting along heat seal lines 302, 304, 306. The slits along heat seal lines 302, 304, 306 may be simultaneously or sequentially. The slitting operation, in some embodiments, may be a perforating operation (or formation of a similar line of weakness) which leaves the sequential packages or pouches 400, 402, 404, 406 attached until later separation. It is noted that, for the configuration of FIG. 4 and similar folded configurations, heat seal line 300 may be considered optional due to the fold in the web or film 100 at machine-direction centerline 106. However, the crushing of reclosure 200 at the centerline 106 would typically be maintained in order to properly join portions of first and second halves 202, 204 of reclosure 200.

Transverse cuts are made, as necessary to form the bottom and top edges 502, 504 of the finished pouches or containers as illustrated in FIG. 13.

In some configurations, the reclosure 200, with the exception of the end crushes, may remain open or non-interlocked, so that product can be filled through the reclosure 200. In other configurations, the packages or pouches 400, 402, 404, 406 may be provided with an interlocked reclosure 200 to a form-fill-seal device (not shown) wherein the bottom seal 502 (see FIG. 13) is formed and the package or pouch is filled through the reclosure 200. Alternately, the form-fill-seal device (not shown) may close the reclosure 200, form a bottom cut and fill through the bottom cut. Further, in some applications the package or pouch may be filled through the open bottom with contents (such as, but not limited to, food or other consumer products) and the bottom seal formed. Still further, the package or pouch may have a bottom seal formed, then contents inserted through the separated reclosure, and then the reclosure is interlocked or otherwise closed. The bottom seal or cut 502 of a package may be the top seal or cut 504 of a prior or subsequent package in the machine direction. That is, these cuts are formed between successive reclosures.

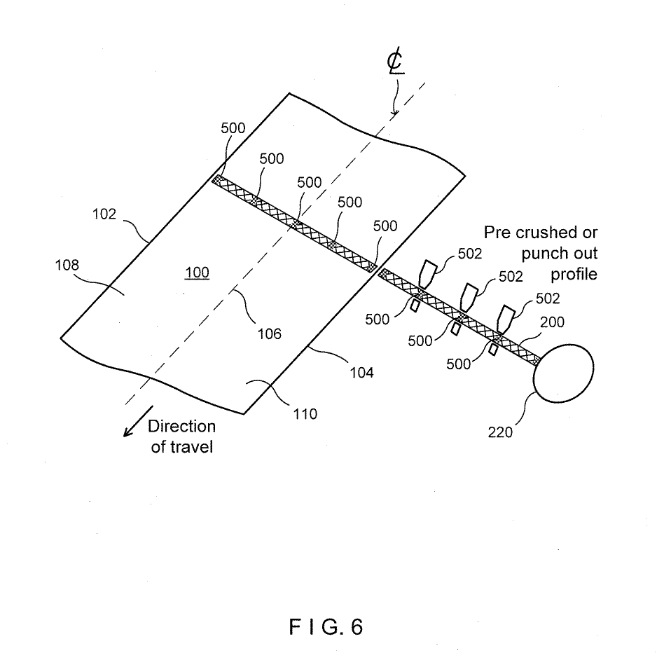

An alternative step is illustrated in FIG. 6. The reclosure 200, particularly if a vector-type reclosure, may be supplied from a spool 220 or similar source, and may be subjected to a pre-crushing or punching step so as to include pre-crushed (or pre-punched) areas 500, formed by crushing or punching devices 502, which would be aligned with the heat seal lines 300, 302, 304, 306, 308 (i.e., the side seals of the resulting pouches), including the fold on the machine-direction centerline 106.

With such a configuration, the reclose feature could be placed onto a multi-up form fill seal line, such as, but not limited to, a Stick-Pak® machine. Transverse direction insertion from multiple stations on opposing sides of the web or film 100 can be achieved. The reclosure is joined 200 and crushed at the edge of each pouch 400, 402, 404, 406, but left open for the fill through operation. Similarly, simultaneous addition of a reclose feature is possible in the transverse direction on extremely wide web whereas web width has been previously limited.

Further typical advantages are the simultaneous creation of multiple reclosable packages and improved conversion efficiency. Moreover, this disclosure could be used for matrix style reclosures and could further be modified to utilize transverse direction zippers or similar reclosures in a fill behind configuration.

Thus the several aforementioned objects and advantages are most effectively attained. Although preferred embodiments of the invention have been disclosed and described in detail herein, it should be understood that this invention is in no sense limited thereby.

What is claimed is:

1. A method for manufacturing a plurality of packages or pouches, comprising the steps of:
providing a first portion of web material in a machine direction;
providing a second portion of web material in a machine direction;
providing a reclosure between and attached to the first and second portions of web material, the reclosure being oriented in a transverse direction;
forming a plurality of machine direction seal lines between the first and second portions of the web; and
forming a plurality machine direction cuts in the first and second portions of the web along at least a portion of the machine direction seal lines.

2. The method of claim 1 wherein the steps of providing first and second portions of web material are performed by the step of providing a single sheet of web.

3. The method of claim 2 wherein the step of providing a reclosure includes the steps of attaching a first half of the reclosure to the first portion of web material, attaching a second half of the reclosure to the second portion of web material, and folding the web material so that the first portion of web material is coextensively aligned with the second portion of web material.

4. The method of claim 3 wherein the folding step brings the first and second interlockable profiles into interlocking engagement.

5. The method of claim 4 wherein the longitudinal line of the folding step is a machine direction centerline of the sheet of web.

6. The method of claim 2 wherein the step of providing a reclosure includes the steps of attaching a reclosure including first and second interlocked halves of the reclosure to a second portion of web material and folding the web material so that the first portion of web material is coextensive with the second portion of web material.

7. The method of claim 2 wherein the reclosure is a self-mating reclosure.

8. The method of claim 1 wherein the first and second portions of web material are separate respective first and second sheets of web material.

9. The method of claim 8 wherein the step of providing a reclosure includes the steps of attaching a first half of the reclosure to the first sheet of web material, attaching a second half of the reclosure to the second sheet of web material, and bringing the first and second sheets of web material into coextensive alignment.

10. The method of claim 9 wherein the step of bringing the first and second sheets of web material into coextensive alignment further brings the first and second halves of the reclosure into interlocking engagement.

11. The method of claim 8 wherein the step of providing a reclosure includes the steps of attaching a reclosure including first and second interlocked halves of the reclosure to the second sheet of web material and bringing the first and second sheets of web material into coextensive alignment.

12. The method of claim 8 wherein the first and second sheets of web are a polymeric material.

13. The method of claim 12 wherein the reclosure is a self-mating reclosure.

14. The method of claim 12 wherein the reclosure includes a first interlockable profile and a second interlockable profile.

15. The method of claim 12 wherein the step of forming a plurality of machine direction seal lines further includes the step of forming crushed areas joining portions of the first and second interlockable profiles to each other.

16. The method of claim 15 wherein the plurality of machine direction seal lines are parallel to each other.

17. The method of claim 16 wherein the step of forming a plurality of machine direction cuts separates the packages or pouches from each other.

18. The method of claim 17 wherein the plurality of machine direction cuts are performed simultaneously.

19. The method of claim 17 wherein the plurality of machine direction cuts are performed sequentially.

20. A method for manufacturing a plurality of packages or pouches, comprising the steps of:
providing a sheet of web material in a machine direction, the sheet of web material including a central half and first and second lateral quarters;
providing a reclosure attached in a transverse direction to the sheet of web material;
folding the first and second lateral quarters over the central half of the sheet of web material;
forming a plurality of machine direction seal lines between the first and second portions of the web; and
forming a plurality machine direction cuts in the first and second portions of the web along at least a portion of the machine direction seal lines.

21. The method of claim 20 wherein the reclosure is a self-mating reclosure extending transversely along the central half and first and second lateral quarters of the sheet of web material.

22. The method of claim 20 wherein the reclosure includes interlocked first and second profiles, the reclosure being attached to the central half of the sheet of web material, and further, after, the step of folding, attached to the first and second lateral quarters of the sheet of web material.
